(19) United States
(12) Patent Application Publication
(10) Pub. No.: US 2021/0201266 A1
(43) Pub. Date: Jul. 1, 2021

(54) SYSTEMS AND METHODS FOR PROCESSING CLAIMS

(71) Applicant: DataInfoCom USA, Inc., Austin, TX (US)

(72) Inventors: Wensu Wang, Katy, TX (US); Chun Wang, Austin, TX (US); Patrick John Thielke, Houston, TX (US)

(21) Appl. No.: 17/063,661

(22) Filed: Oct. 5, 2020

Related U.S. Application Data
(63) Continuation-in-part of application No. 16/732,281, filed on Dec. 31, 2019.
(60) Provisional application No. 62/976,191, filed on Feb. 13, 2020.

(51) Int. Cl. G06Q 10/10; G06F 40/40; G06Q 40/08; G06N 20/00; G06K 9/00

(52) U.S. Cl. CPC G06Q 10/10; G06F 40/40; G06K 9/00; G06N 20/00; G06Q 40/08

(57) ABSTRACT

Methods, systems and apparatuses, including computer programs encoded on computer storage media, are provided for processing claims using both unstructured and structured policy documents and claim data. Policy rules, benefit calculation formulae, necessary data points, and benefit requirements are extracted from policy documents. Unstructured claim data is converted to a structured form using natural language processing, information extraction, and AI techniques to identify and extract relevant information, including values for the data points and benefit conditions, then the combined structured data and converted unstructured data is processed to get all values for the data points and applicable benefit conditions. The relevant claim information is then further processed according to the policy rules and benefit calculation formulae to generate a benefit payment amount and entitled additional benefits.

### CROSS-REFERENCE TO RELATED APPLICATIONS

The present application is a continuation-in-part of U.S. patent application Ser. No. 16/732,281, entitled “SYSTEMS AND METHODS FOR CLAIMS PROCESSING,” filed Dec. 31, 2019, and claims the benefit of U.S. Provisional Patent Application No. 62/976,191, filed Feb. 13, 2020, each of which is hereby incorporated by reference herein in its entirety.

### BACKGROUND

The present application relates to the use of natural language processing techniques and other artificial intelligence technologies in the processing of claims made pursuant to a policy, such as an insurance policy or terms and conditions. More specifically, the present application relates to the processing of claims using all available structured and unstructured data related to each claim, and to make determinations related to the processing of each claim.

Many current procedures related to the processing of claims, e.g., insurance claims (such as claims on workers' compensation, income protection, life insurance, trauma insurance, total and permanent disability, property and casualty, etc.), warranty claims, rebate claims, item return claims, credit card claims (such as price protection, extended warranty, etc.), etc., require significant manual effort. As such, these procedures are prone to extensive and expensive errors. There remains a need for methods that can automatically, more accurately, and with more transparency, process claims of any type using all the available documents, and without error.

### SUMMARY

In accordance with the foregoing objectives and others, exemplary methods and systems are disclosed herein for processing claims using both unstructured and structured policy data, terms and conditions data, and/or claim data. Policy rules, terms and conditions, benefit calculation formulae, necessary data points, and benefit requirements are extracted from policy and other documents. Unstructured claim data, including claim documents, is converted to a structured form using natural language processing, information extraction, image processing, and other related AI techniques to identify and extract relevant information, including values for the data points and benefit requirements, then the combined structured data and converted unstructured data is processed to determine values for the data points and applicable benefit conditions. The relevant claim information is further processed according to the policy rules, terms and conditions, and/or benefit calculation formulae to generate a benefit payment amount.

In an embodiment, disclosed herein is a method for processing a claim from a claimant, the method comprising: receiving claim information; determining a claim type based on the claim information; identifying at least one applicable policy based on the claim information and the type of claim; retrieving at least one policy rule for the at least one applicable policy; determining at least one claim variable based on the at least one policy rule; identifying at least one claim document likely to have information relevant to the at least one claim variable; extracting the relevant information from the at least one claim document; determining a value for the at least one claim variable based on the extracted information; and calculating a payment amount based on the determined value.

In another embodiment, disclosed herein is a system comprising one or more processors and one or more storage devices storing instructions that when executed by the one or more processors cause the one or more processors to perform operations comprising: receiving claim information; determining a claim type based on the claim information; identifying at least one applicable policy based on the claim information and the type of claim; retrieving at least one policy rule for the at least one applicable policy; determining at least one claim variable based on the at least one policy rule; identifying at least one claim document likely to have information relevant to the at least one claim variable; extracting the relevant information from the at least one claim document; determining a value for the at least one claim variable based on the extracted information; and calculating a payment amount based on the determined value.

In another embodiment, disclosed herein is a computer program product encoded on one or more non-transitory computer storage media, the computer program product comprising instructions that when executed by one or more processing means cause the one or more processing means to perform operations comprising: receiving claim information; determining a claim type based on the claim information; identifying at least one applicable policy based on the claim information and the type of claim; retrieving at least one policy rule for the at least one applicable policy; determining at least one claim variable based on the at least one policy rule; identifying at least one claim document likely to have information relevant to the at least one claim variable; extracting the relevant information from the at least one claim document; determining a value for the at least one claim variable based on the extracted information; and calculating a payment amount based on the determined value.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic illustration of one example of a claim processing system.

FIG. 2 is a schematic illustration of one example of a claim management system.

FIG. 2 illustrates an example end-to-end method for automatically processing and paying a claimed benefit.

FIG. 3 illustrates a different versions of policy documents for a particular policy.

FIG. 4 illustrates an example method for receiving and processing claim type information.

FIG. 6 illustrates an example method for receiving and processing claim data point information.

FIG. 7 is an example of an image file containing scanned machine-typed text.

FIG. 8 is an example of an image file containing handwritten text.

FIG. 9 is an example of an image file including both machine-typed and handwritten text.

FIG. 10 illustrates an example method for extracting policy rules from policy documents.

FIG. 11 illustrates an example claim summary screen for claim management.

FIG. 12 illustrates an example claim drill down screen for claim management.

FIG. 13 is a schematic diagram of an example computing system for any of the systems described herein.

### DETAILED DESCRIPTION

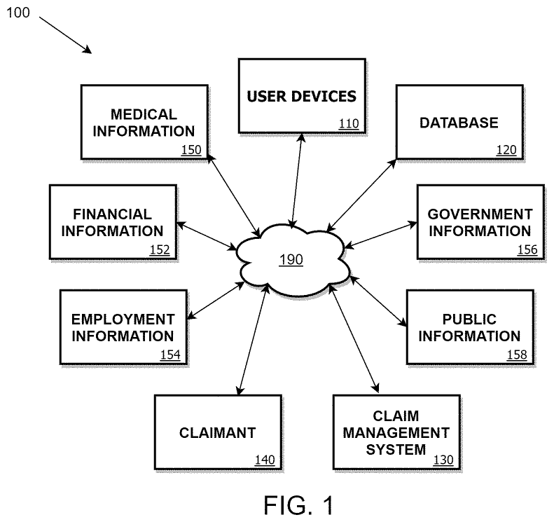

Embodiments of the present disclosure are best understood by referring to FIGS. 1-13 of the drawings, like numerals being used for like and corresponding parts of the various drawings.

Referring to FIG. 1, a block diagram of an exemplary system 100 for use in processing claims is illustrated. The claim processing system may include user devices 110, a database 120 which stores both structured and unstructured data, a claim management system 130, and may receive input from a claimant system or device 140 and/or one or more third party information sources (150, 152, 154, 156, 158), including medical information sources 150 (e.g., doctors' offices, hospitals, etc.), financial information sources 152 (e.g., credit bureaus, etc.), employment information sources 154 (e.g., the claimant's employer or former employer, etc.), government information sources 156 (e.g., tax bureaus, etc.), and public information sources 158 (e.g., public media websites, etc.). The user devices, database, claim management system, claimant device, and third party information sources may be remote from each other and interact through a communication network 190. Non-limiting examples of communication networks include local area networks (LANs), wide area networks (WANs) (e.g., the Internet), etc.

In certain embodiments, a user, such as a claim manager, may access the claim management system 130 and/or the database 120 via a user device 110 connected to the network 190. A user device 110 may be any computer device capable of accessing any of the claim management system or the database, such as by running a client application or other software, like a web browser or web-browser-like application.

The database 120 is adapted to receive, determine, record, transmit, and/or merge information for any number of policies, policy documents, terms and condition documents, policyholders, customers, claims, claim documents, inquiries, potential contacts, and/or individuals. The database 120 may store both unstructured and structured data, including formerly unstructured data that has been converted to structured data, e.g., structured data extracted from policy documents, terms and condition documents, claim documents, etc.

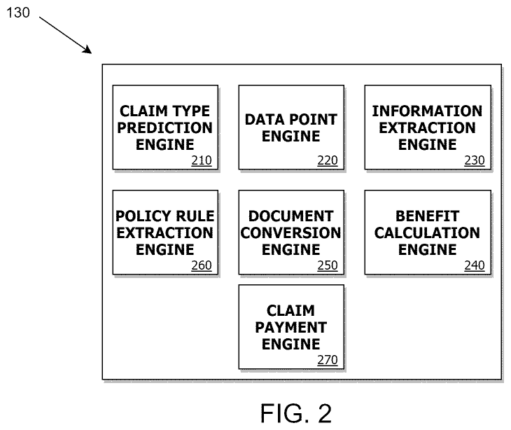

The claim management system 130 is adapted to receive claim data from claimant 140 and/or third party information sources (150, 152, 154, 156, 158), process received claims based on policy documents, terms and condition documents, policy rules, and received claim data, and make claim payments to claimants. FIG. 2 is a more detail schematic illustration of one example of a claim management system 130. As illustrated, the claim management engine may include a claim type prediction engine 210, a data point engine 220, an information extraction engine 230, a benefit calculation engine 240, a document conversion engine 250, a policy rule extraction engine 260, and a claim payment engine 270. These engines are configured to communicate with each other to manage the entire process of claim management, from the initial receipt of a claim to the payment of the claim.

The rest of this disclosure describes a particular implementation related to workers' compensation, disability, and/or income protection benefits, but the same principles and processes apply to the processing and management of other types of claims. For instance, the same processes may be used to calculate claims made with respect to other types of insurance policies, e.g., life/death insurance, trauma insurance, partial disability, total and permanent disability, and property and casualty (e.g., auto and home) policies. Additionally, the same processes may be used to calculate other types of claims made under a terms and conditions document, e.g., credit card terms (for charge backs, price protection, extended warranties, trip cancellation, etc.), warranties, item returns, rebates, etc.

Claim type prediction engine 210 is configured to use the initial claim information received by the system (e.g., the initial information from the claimant) to determine the type of benefit claim, e.g., life/death insurance, disability insurance, etc. The claim type prediction engine may comprise a trained prediction model, such as an artificial neural network (ANN). If so, the model will have been trained on historical claim information that has been labeled to identify the claim type of each claim.

Policy rule extraction engine 260 is configured to extract rules from insurance policy and/or terms and conditions documents. The extracted rules may include benefit conditions, such as that the claimant be under medical care, that the claimant is unable to work in his or her primary occupation, that the claimant's condition be caused by a sickness or injury, etc.

The extracted rules may also include benefit calculation formula(e), as well as data points necessary for the calculation of any formula. For example, a disability benefit calculation may require the claimant's pre-disability income, among other data points. The rules extracted from the policy document will include a list of all of the data points that are required to calculate the claimed benefit.

Data point engine 220 is configured to determine values for the benefit conditions (e.g., the condition is met (true) or not met (false)), as well as the data points needed for the applicable benefit calculation formula(e). The data point engine can determine which conditions and/or data points have values (e.g., as extracted from the initial claim information submitted by the claimant, input by the claim manager, etc.) and, for those that are unassigned, manage the document conversion engine 250 and information extraction engine 230 to gather the needed information from documents relevant to the claim using NLP or other AI techniques.

For each data point and benefit condition, the data point engine keeps a list of the types of documents that may contain the needed information. The data point engine can check to see if any of the relevant documents have been loaded in the system (e.g., are associated with the claim in the database), and if so, have the document(s) processed by the document conversion engine 250 and information extraction engine 230. If no relevant documents are available, the data point engine can notify the case manager that further documentation is required.

Document conversion engine 250 is configured to convert documents into a form that is interpretable by the information extraction engine. In an embodiment, all documents are converted, through one or more processes, to text format. For example, a pdf document may be converted to text by extracting the embedded text and/or using optical character recognition (OCR) techniques. Similarly, a scanned machine-typed document may be converted to text using OCR techniques.

Handwritten documents may be converted to text using deep learning and/or machine learning techniques, such as one or more trained neural networks. For documents containing both machine-typed portions and handwritten portions, the machine-typed and handwritten contents are divided into segments, and then separately processed using the techniques outlined herein.

Documents converted by the document conversion engine also include audio and video files, e.g., audio recordings of phone calls, video recordings of video calls, video chats, etc. Such calls may be between parties relevant to the claim, e.g., the claimant, doctors, employers, etc.

Information extraction engine 230 uses natural language processing (NLP) techniques to extract the required information from the (original or converted) text documents. Such techniques may include text normalization (e.g., converting to a consistent case, removing stop words, lemmatizing, stemming, etc.), keyword recognition, part of speech tagging, named entity recognition (NER), sentence parsing, regular expression searching, word chunk searching (e.g., using a context-free grammar (CFG)), similarity searching (e.g., with word/sentence embedding), machine learning models, etc.

Benefit calculation engine 240 is configured to calculate the benefit due to the claimant based on the benefit calculation formula extracted by the policy rule extraction engine 260 and the data points determined by the data point engine 220. In an embodiment, the benefit calculation engine may first test that any required benefit conditions are met (e.g., the claimant must be under medical care). If the benefit conditions are met, then the benefit calculation engine can calculate the benefit amount using the data points.

The benefit calculation engine may comprise a web-based (or other type of) interface through which a claim manager (or other user) may view the formula used, the data points that are inputs to the formula, and the amount calculated. Through this interface, the claim manager may be notified of certain conditions, e.g., data point engine 220 cannot calculate a necessary data point, an exception is encountered (e.g., necessary medical or financial information to assess a claim's benefit type or calculate the benefit amount is missing, a handwritten document cannot be converted to text, etc.), a calculation requires verification (e.g., certain pre-disability income calculations, complex cases that require specific domain knowledge), an action needs to be taken (e.g., a claim payment is due in X days, a waiting period is due in Y days, etc.), etc. In an embodiment, the interface may also enable the claim manager to approve the payment to the claimant. Alternatively, the payment may be processed automatically.

Claim payment engine 270 is configured to process and make payments to claimants based on payment amounts calculated by the benefit calculation engine 240.

Modifications, additions, or omissions may be made to the above systems without departing from the scope of the disclosure. Furthermore, one or more components of the systems may be separated, combined, and/or eliminated. Additionally, any system may have fewer (or more) components and/or engines. Furthermore, one or more actions performed by a component/engine of a system may be described herein as being performed by the respective system. In such an example, the respective system may be using that particular component/engine to perform the action.

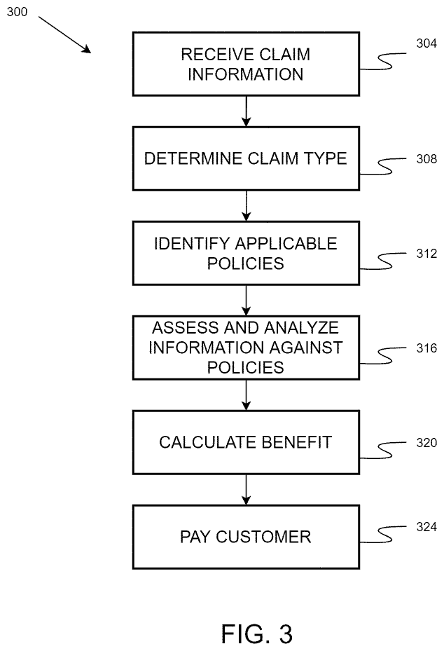

FIG. 3 illustrates an example method 300 for automatically processing and paying a claimed benefit end-to-end, such as may be performed by the claim management system 130. Such benefits may be based on an insurance policy or investment vehicle, e.g., income protection insurance, total and permanent disability insurance, trauma and/or life insurance, etc. In one embodiment, the disclosed automatic solution for benefit processing comprises several processes, including: receiving of claim information, collection of claims-related documents and retrieval of information from the collected documents, identification of the claim type, retrieval and/or creation of the rules applicable to the identified claim type (e.g., based on policy documents), benefit calculation based on the rules and claim information, and benefit payments. One or more AI models, including NLP models, may be used by each component to automate claim type identification, rules creation and/or retrieval, information recognition, collection, and extraction, calculations, payments, and any necessary reviews.

In step 304, claim information is received. Such information may include unstructured data and structured data in various formats. Unstructured data may include text documents (e.g., paper or electronic claim forms, claim notes, medical reports, claimant financials, etc.), images (e.g., of injuries), audio recordings (e.g., of a phone conversation with the claimant), etc. The unstructured claim information is converted to a machine readable format if necessary (e.g., paper documents are scanned), then analyzed to extract applicable information. Claim information may also be received in structured formats, e.g., information retrieved from a customer database.

Claim data may include policyholder variables (e.g., personal data, financial data, asset data, claim history data, employment data, etc.) for the relevant policy, policy data for the relevant policies, and data related to the current claim and claimant. Policyholder variables may also include policy deductibles, policy discounts, policy limits, premium development history, and the policyholder credit score or other information regarding the policyholder's financial status or history. The policy variables may include all information relating to the policy, e.g., type, term, effective data, coverages, etc.

The claimant variables may include all information relating to the claimant, e.g., identity of the claimant, indemnity payouts, submitted bills, medical history, prior claim history, prior injury history, etc.

The claim variables may include all information relating to the claim, e.g., identity of the claimant and the insured, claim status, claim history, claim payouts, submitted medical bills, and any other information relevant to the claim.

In step 308, the claim type is determined from the claim information. A trained AI model may be used to determine the claim type. Such a model may have been trained using historical claim data and corresponding historical claim types, using known techniques.

In step 312, one or more applicable policies are identified based on the claim information and the claim type. The claim management system 130 keeps a correspondence between claimants, claim types, policy effective dates, and policies in an appropriate data store, e.g., one or more database tables in database 120. Relevant inputs (e.g., claimant ID, claim type, date of occurrence, insurance schedule, etc.) may be used to query the database or otherwise identify applicable documents, which may include policies, optional benefits, ancillary benefits, pass-backs, etc. The system may store multiple versions of policy documents for each policy to provide for policy upgrades.

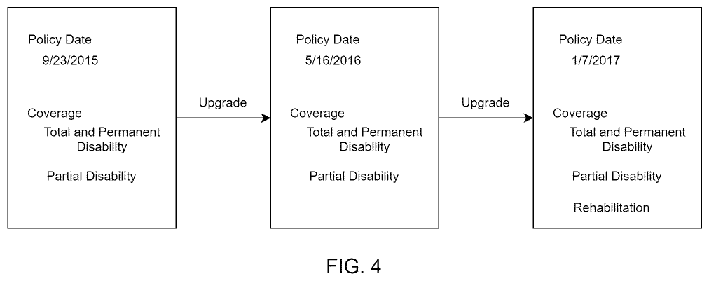

FIG. 4 is an illustration of upgrades and/or other versions of policy documents for a particular policy, including the types of benefits that each policy document covers. As shown, the illustrated policy started on Sep. 23, 2015, and there were version changes on May 16, 2016; and Jan. 7, 2017. Each of the policy versions includes provisions related to partial disability and total disability. The Jan. 7, 2017 version also includes a provision related to rehabilitation expenses. Policy information, such as policy start and/or upgrade dates, applicable policy provisions, and policy document identifiers (which reference the actual policy documents) may be stored in a structured manner in database 120.

In an embodiment, for a policy with multiple versions (e.g., upgrades or pass-backs), the benefit amount is calculated with respect to each policy version between the policy commencement date and the claim occurrence date, and the most favorable version is applied to the policy holder if required.

After the policy or policies are identified, unstructured information regarding the policy or policies is retrieved from the database and document management system. The information may include original benefit documents, including policies, policy options, ancillary benefits, policy upgrades, pass-backs, etc. Policy benefit rules are then extracted from the retrieved policy documents using NLP techniques. The rules may include, but are not limited to, policy terms, benefit calculation formulae, etc. Each rule may include one or more data points whose values must be determined through analysis of the claim information and/or claim documents. Extraction of policy rules from original policy documents is discussed in more detail hereafter.

Alternatively or additionally, structured information regarding the applicable policies is also retrieved from the database. Such information may include previously extracted policy rules, including policy terms, benefit calculation formulae, data points, etc.

In step 316, the claim information is assessed and analyzed against the policy rules. In some cases, the retrieved or extracted policy rules may identify one or more data points (including benefit conditions) that need to be determined based on claim information. For example, a specific income protection policy may not be payable unless the claimant is under medical care, among other requirements. In this case, the system determines, using the received claim information, whether the claimant is under medical care.

In an embodiment, the system extracts information from received claim documents in order to determine values for the data points identified by the policy rules. Such extraction can include one or more Natural Language Processing (NLP) techniques. If a value for a required data point cannot be determined using the received claim information and documents, the system may flag the case manager that human intervention is needed to make a decision, e.g., to require additional documentation if necessary.

In step 320, the benefit is calculated based on the extracted terms, formulae, and calculated data points, including conditions. In an embodiment, for cases with policy upgrades (e.g., updates or pass backs), the most favorable payment will be determined if required. This is accomplished by calculating payment amounts under each policy version, and then selecting the highest payment amount.

In step 324, the payment to the customer is made. In an embodiment, the payment may be reviewed by a case worker and/or manager prior to the payment being made. In this case, the proposed payment is automatically sent to the case manager for review and, upon approval, automatically sent to the customer. Any necessary reports can also be generated automatically.

FIG. 5 illustrates an example method 500 for receiving and processing claim type information (see FIG. 3 at 304). Method 500 may be implemented by the claim type prediction engine 210. In step 504, any non-computer readable documents are converted to a computer-readable form, e.g., paper documents are scanned into the system (e.g., as PDF files) and converted into text. The conversion may be aided by document metadata and document templates. The conversion may be performed by document conversion engine 250.

In step 508, a new claim is initialized in the system if necessary. In step 512, the claim data can be extracted from the received claim documents by information extraction engine 230, using natural language processing (NLP) techniques.

In step 516, the claim type prediction engine 210 then predicts the claim type, e.g., total and permanent disability, partial disability, life insurance death benefit, trauma benefit, workers compensation, etc., based on claim information or a trained machine learning prediction model. The prediction model can be previously trained using historical claim data as the input and historical claim type data as the target.

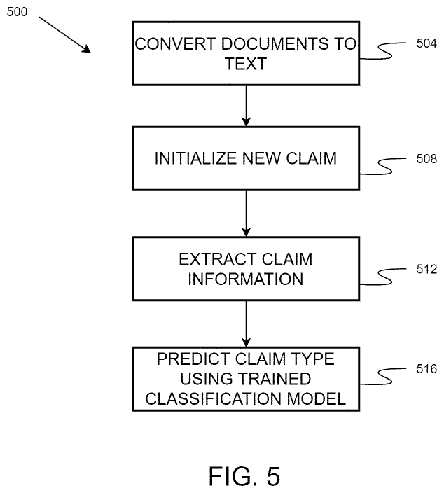

FIG. 6 illustrates an example method 600 for assessing and analyzing claim data point information against the policy (see FIG. 3 at 316). Method 600 may be implemented by the data point engine 220.

In step 604, one or more benefit conditions that need to be calculated are determined based on the policy rules retrieved at step 312. For example, with respect to a total disability benefit of a workers' compensation or income protection plan, such benefit conditions may include, but are not limited to, whether the claimant is under medical care, the incurred date of the incident giving rise to the claim, whether the claimant is capable to work in his or her occupation, whether the claimant is capable to work in any occupation, whether the claimant is experiencing sickness or injury, whether the claimant is current employed, how long the claimant has been covered, and many more.

In step 606, one or more data points that need to be calculated are determined based on the policy rules retrieved at step 312. With respect to a total disability benefit of a workers' compensation or income protection plan, such data points may include, but are not limited to, the existence and amount of any offsets, applicable policy changes that benefit the claimant (e.g., upgrades and/or passbacks), the claimant's pre-disability income, ancillary benefits, etc.

In step 608, one or more documents that may include information helpful in determining the value of each benefit condition and data point are identified. The system stores a correlation between the benefit conditions and data points and the documents that may contain information relevant to the variables.

The following examples apply to a workers' compensation or income protection plan. For an “under medical care” condition, relevant documents may include medical records, including doctors' medical opinions, transcripts of phone calls regarding the claim (e.g., between claim managers and claimants), treatment reports, clinical notes, hospital records (e.g., discharge reports), etc.

For an “incurred date” condition or data point, relevant documents may include claim forms, doctors' medical opinions, clinical notes, transcripts of phone calls regarding the claim, transcripts of phone calls with the employer, etc.

For a “capable of working in one's occupation” condition, relevant documents may include doctors' medical opinions, case manager notes, occupational details forms, independent medical reviews, etc.

For a “capable of working in any occupation” condition, relevant documents may include doctors' medical opinions, transcripts of phone calls with regarding the claim (e.g., between claim managers and claimants), treatment reports, clinical notes, hospital records, work capacity reports (including checklists), activity diaries, independent medical reviews, etc.

For a “sickness or injury” condition, relevant documents may include doctors' medical opinions and/or notes, hospital records, independent medical reviews, etc.

For an “offset” data point, relevant documents may include doctors' medical opinions, claim forms, transcripts or notes from phone calls regarding the claim (e.g., between claim managers and claimants), etc.

For a “pre-disability income” data point, relevant documents may include tax returns, business tax information, pay slips, etc.

In step 612, for each data point, if it is not already assigned a value (e.g., by the case manager), the system will attempt to determine its value by extracting the information (as described in more detail below) from available documents of the identified types.

In step 616, the claim is flagged for further review (e.g., by a case manager) under several different conditions, including but not limited to: 1) if none of the identified types of documents are available; 2) if a value for a data point cannot be determined from the available documents; 3) if the confidence score output by the handwriting recognition model (discussed below) is too low; 4) if multiple documents containing information relevant to the data point are available, and the information extracted from one such document contradicts information extracted from another such document; or 5) if a calculation needs to be verified, e.g., for certain pre-disability income calculations and other complex calculations that require specific domain knowledge.

If the claim is flagged for further review, the case manager may request any additional documents necessary to calculate values for the missing data points. In an embodiment, the system can automatically request the necessary documents and, when the documents are received, extract the information for the data point.

As discussed herein, the system is able to automatically extract information from documents using document conversion engine 250 and information extraction engine 230. Information may be extracted in various ways, depending on the type of document and the specific information needed. Claim documents may include pdf documents (e.g., filled pdf forms, pdf text documents (including tax returns and policy documents), handwritten pdf documents, etc.), text documents, scanned images (e.g., of text documents, machine-typed documents, receipts, manually-filled out forms, and other handwritten documents, such as doctors' notes, etc.), program-generated images, audio and/or video recordings of phone and/or video calls, etc.

Pdf documents may be converted to text, and processed as a text document by the information extraction engine 230. In an embodiment, pdf documents that include tables may first be segregated into table-containing parts and other parts, and the parts converted to text separately, e.g., using one or more pdf conversion packages. In cases where the pdf document is unable to be converted to text directly (e.g., the pdf does not follow pdf ISO or other standards, is a wrapper for images, etc.), the pdf may be transformed into one or more image files and processed as such.

The document conversion engine 250 is also configured to convert image files to text. Any image file format (e.g., jpeg, png, gif, bmp, tiff, svg, etc.), including image file formats that will be created in the future, may be converted using this method.

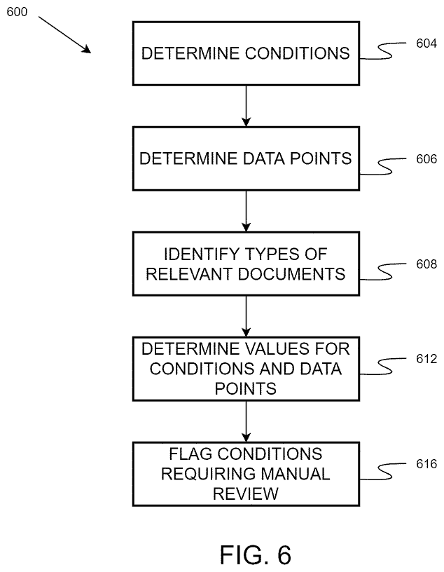

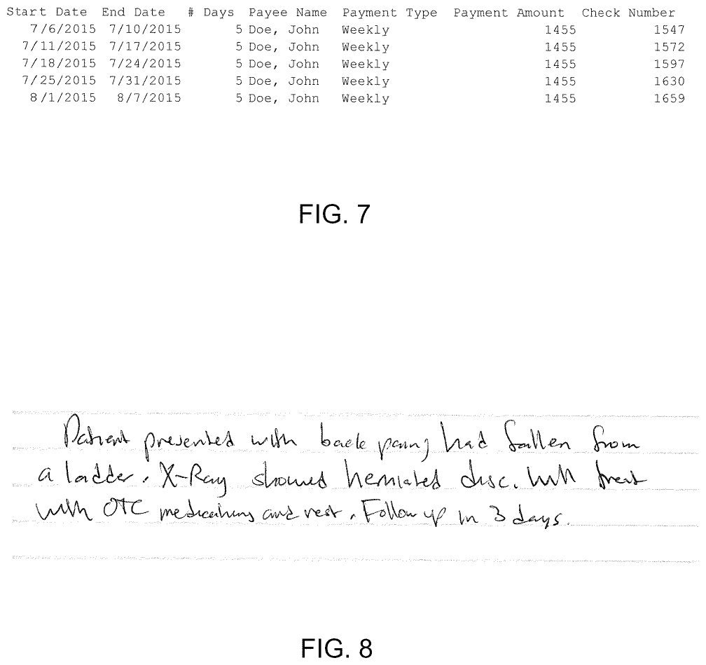

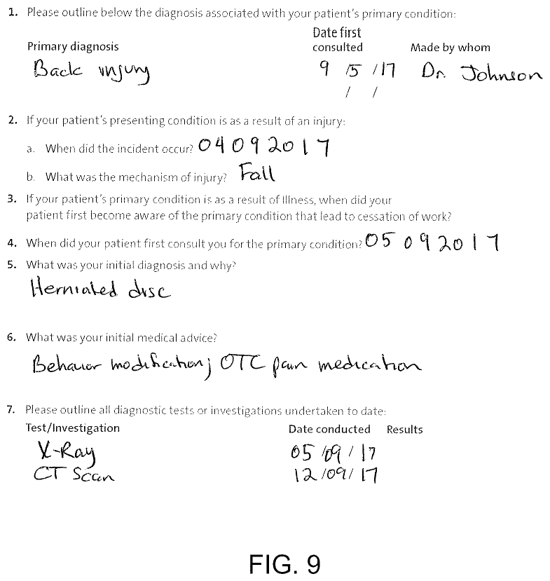

Image files documents may be generally divided into three categories: 1) image files consisting of machine-typed text (see FIG. 7); 2) image files consisting of hand-written text (see FIG. 8); and 3) image files with both (see FIG. 9). Images of any category may first be preprocessed, using techniques including skew correction, perspective transformation, and/or noise removal. Images may also have morphological transformations applied to them, including dilation, erosion, opening (erosion followed by dilation), closing (dilation followed by erosion), etc., to better identify lines of text.

After preprocessing, an image including only machine-typed text may be converted to text using OCR, then the text document may be processed by the information extraction engine 230. Tables in the image may be separately identified and processed by OCR techniques that preserve the table structure during the conversion to text. Images may be converted as a whole or line-by-line.

Images containing hand-written text are converted to text using a trained deep learning model, which is trained at the text line level. In an embodiment, the deep learning handwriting recognition model comprises a convolutional neural network (CNN) connected to a recurrent neural network (RNN), which is in turn connected to a connectionist temporal classification (CTC) scoring function. The CNN is trained to extract a feature sequence from the text line image. The RNN propagates the information from the CNN through the feature sequence, and the CTC classifies the output character. The outputs of the trained handwriting recognition model include a sequence of identified characters and a confidence score. The handwriting recognition model can be trained using tagged handwriting line samples.

To process an image containing handwritten characters, the document conversion engine 250 first separates the handwriting into lines of text (e.g., using dilation and/or erosion filters), and then converts each line of handwritten text using the trained deep learning model. The resulting text can then be processed by the information extraction engine 230.

Documents that include both machine-typed text and handwritten text, e.g., manually filled-out forms (see FIG. 9), are commonly used in the medical industry. Such forms generally include a series of questions or other machine-typed labels that identify needed information, and spaces in which to write supplied information. To automatically process such a form, the document conversion engine 250 includes a text classifier that typed versus handwritten text in an input image of a line of text. In an embodiment, the classifier is a trained deep learning model that classifies text lines into machine-typed text lines and handwritten text lines. In a particular embodiment, the deep learning model may comprise a convolutional recurrent neural network. The model may be trained on labeled machine-typed and handwritten text lines.

After each line is classified by the text classifier, it is converted to text using appropriate methods, e.g., OCR for machine-typed text, and the trained handwriting recognition model for handwritten text.

For each line of scanned text in image format that is converted to text format, whether using OCR or the trained handwriting recognition model, positional relationships between the converted lines are also stored. For example, the original location of each line in the document may be stored (e.g., using x and y coordinates) along with the converted text. This enables proximity and/or context information to be used by the information extraction engine when extracting needed information from the document.

If the image is unable to be converted to text, e.g., it is unreadable, it contains characters that cross a line, etc., the claim is flagged for review by a case manager and the image is identified for easy retrieval by the case manager. In an embodiment, the problematic portions of the image are highlighted.

After the document(s) is converted to text, the information extraction engine 230 uses NLP techniques to extract the needed information. For example, in a form, the words of the questions (or other labels) may be parsed using NLP techniques to identify where in the form the needed information may be found.

After the location of the question (or label) for the needed information is identified, the location of the answer is determined. This will generally in proximity to the question or label, e.g., for forms, it will generally be underneath the question (or label) or to the right of the question. The stored line locations (e.g., x and y coordinates) can be used to identify lines of text in close proximity to the question or label, as such lines are more likely to include the information for the data point. In some instances, the lines containing a possible answer will be underlined, or surrounded by a box. The converted text of the lines in proximity may then be analyzed to determine the value of the data point.

For example, if a date is required, e.g., the date of injury, the incurred data, the date of a doctor's diagnosis, etc., words indicating a date may be identified in the form. Such words include, for example, ‘date’, ‘when’, etc. The type of date may also be identified via keywords such as ‘injury’ for date of injury, etc.

After it is determined that the needed date is in the document, the actual information, e.g., the value for the date, is identified using NLP techniques. Because the context of each line of text is saved (e.g., its position in the document), the system can search for dates in nearby text. For example, text in date format near the words indicating the date may be identified and used as the value of the data point.

For the “offset” data point, relevant key words include phrases that indicate workers' compensation, such as “workers compensation,” “W/C,” “WC,” “worker's comp,” “work injury,” “work accident,” “receive a payment,” “lump sum,” “payout,” etc.; phrases that indicate another insurance policy, such as “other life insurance,” “disability benefit,” “TPD,” “total and permanent disability,” “trauma,” names of other insurance companies, etc.; phrases that indicate the injury was due to an automobile accident, such as “MVA,” “motor vehicle accident,” “car accident,” etc.; and phrases that indicate a government benefit, such as “common law,” “center link,” “government benefit,” “social security,” etc.

For the “capable of working in any occupation” data point, relevant key words include “hospital,” etc. For the “sickness or injury” data point, relevant key words include words related to sickness, e.g., “cancer,” “stroke,” “diabetes,” etc. and words related to injury, e.g., “fracture,” names of specific body parts, etc.

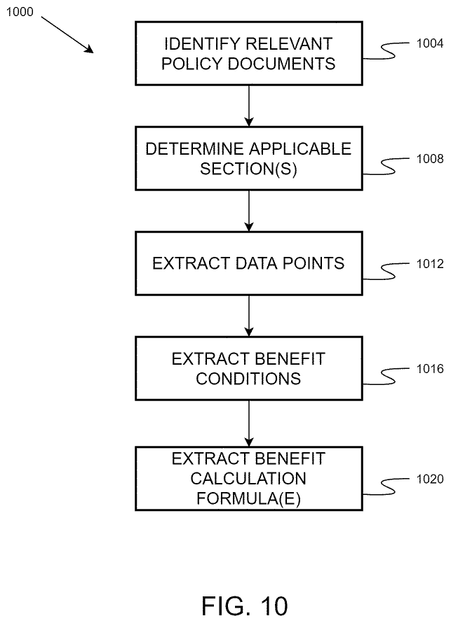

FIG. 10 illustrates an example method 1000 for extracting policy rules from policy documents, as may be implemented by policy rule extraction engine 260. In step 1004, policy documents relevant to the submitted claim are located. In an embodiment, an index or table may be used to look up the applicable documents based on claim information, such as claim type, incurred date, occupation code, basic policy information etc. The following steps are performed for each identified policy document.

In step 1008, the applicable section of the policy document, based on the claim type, is determined. In an embodiment where policy documents are structured into sections with headings, the system may locate the applicable section of the policy based on the textual content of the headings. For example, if the policy document includes sections with headings including the terms “Total disability” and “Partial disability”, the system identifies the “Total disability” section as containing the relevant policy clauses to determine if a claim is entitled a the “Total Disability” benefit.

Similarly, in an embodiment where policy documents include a table of contents, the chapter titles may provide context clues for which chapters are applicable. Policy documents may include both a table of contents and section headings, and in such cases, both may be used to identify the applicable section(s).

In step 1012, required data points and data types of each data point are determined based on the individual clauses of the identified section of the policy document. Such data points may include pre-disability income, offset amounts, medical status (e.g., whether under medical care), working status, claimant's capability of doing work, type of plan, etc.

For example, an example policy clause may read:
We will pay up to $100 per day for up to 90 days for each day the immediate family member has to stay away from home after the end of the waiting period.

The policy rules extraction engine is able to parse this clause to identify several important data points, including: 1) per diem amount (e.g., $100); 2) maximum time period (e.g., 90 days); 3) qualified payee (e.g., immediate family member); and 4) qualified action (e.g., stay away from home). In clauses where a maximum payable amount is used instead of a maximum time period, the maximum payable amount is identified.

The policy rules extraction engine uses NLP techniques to parse the clause, including key word recognition, part of speech tagging, word chunking, etc. For example, key words that indicate a per diem amount include “per day,” etc.

In step 1016, benefit conditions are determined based on the individual clauses of the identified section of the policy document. Benefit conditions may include one or more of the required data points identified in step 1012. Such conditions include, but are not limited to, whether the claimant is under medical care, the claimant's occupation, the claimant's ability to work in his or her regular occupation, the claimant's ability to work in any occupation, whether the claimant is currently working in any occupation, and whether the claimant's condition is because of injury or sickness.

For example, the text of the policy document may recite:
The person insured is totally disabled if, because of an injury or sickness, he or she is: 1) not capable of doing the important duties of his or her occupation; 2) not working in any occupation (whether paid or unpaid); and 3) under medical care.

The policy rules extraction engine is able to parse this clause and determine 4 requirements for a benefit: 1) the claimant is not capable of doing the important duties of his or her occupation; 2) this condition is because of an injury or sickness; 3) the claimant is not working in any occupation; and 4) the claimant is under medical care. The system parses the clause using NLP techniques, such as key word identification, part of speech tagging, word chunking, etc.

For example, the policy rules extraction engine can determine that the requirement of “injury or sickness” exists because of the presence of the keywords “injury” and/or “sickness” in the clause. Similarly, “under medical care” indicates the requirement of being under medical care, “not working” indicates the requirement of not working in any occupation, and “not capable” indicates the requirement of not being capable of doing the important duties of his or her occupation.

In step 1020, the benefit calculation formula is extracted from the identified section of the policy document using similar NLP techniques.

In an embodiment, instead of extracting information from policy documents each time a claim is processed, policy documents may be preprocessed for each policy document relevant to a claim type, and a lookup table generated that creates a correspondence between claim types and policy rules, conditions, data points, etc.

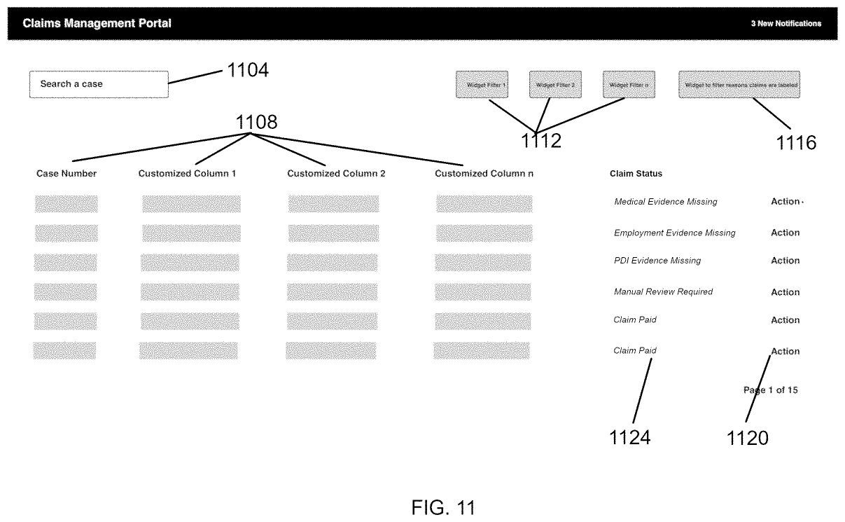

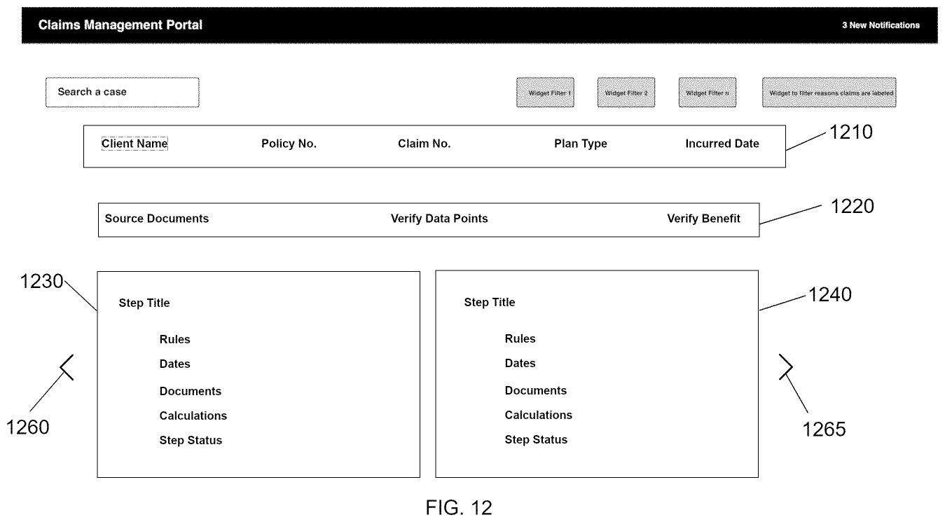

FIGS. 11-12 illustrate an example interface for case (e.g., claims and claimants) management. As shown in FIG. 11, a case summary screen includes a case search box 1104, columns 1108 for displaying different aspects of each case (e.g., case number, etc.), widgets 1112 for filtering the displayed cases, widget 1116 for filtering displayed claims based on the ‘claim status’ field, and action buttons 1120. Claim status column 1124 identifies the status of each claim, e.g., if a claim has been paid, if additional documentation is required (e.g., medical, financial, etc.), if manual review by a claim manager is required, etc. The system flags a claim for manual review under certain conditions (which are flexible and based on the type of claim), e.g., data point engine 220 cannot calculate a necessary data point, an exception is encountered (e.g., necessary medical or financial information to assess a claim's benefit type or calculate the benefit amount is missing, a handwritten document cannot be converted to text or a conversion to text has too low of a confidence score, etc.), a calculation requires verification (e.g., certain pre-disability income calculations, complex cases that require specific domain knowledge), an action needs to be taken (e.g., a claim payment is due in X days, a waiting period is due in Y days, etc.), etc. If an action button 1120 is selected, a drill down window for the corresponding claim is shown.

FIG. 12 illustrates an example drill down window after an action button is selected. As illustrated, a drill down screen includes a claim information panel 1210, a progress panel 1220, and one or more detail panels 1230 and 1240. The claim information panel 1210 includes information about the claim, such as the client name, the client's policy number, the claim number, and the claim incurred date. The progress panel 1220 shows which steps in the claim management process have been successfully completed, e.g., by changing the color of the progress text (e.g., source documents, verify data points, verify benefit, etc.).

Detail panels provide more information about a currently selected claim management step. As shown in FIG. 12, multiple detail panels are shown, but one or more detail panels may be displayed, depending on the amount of information that needs to be displayed to the user. Arrows 1260 and 1265 allow the claim manager to move back and forth between claim management steps.

Inside each claim detail panel, information about a claim step is displayed. Such information may include the name or purpose of the step, a link to applicable definitions related to the step, a link to all applicable documents related to the step, an indication for whether the step has been completed, and any amounts for the step. For example, for an “incurred date” step, the definition (from applicable policy documents), a link to documents from which the incurred date was calculated (e.g., a doctor's opinion), and a calculated date may be displayed in a claim detail panel.

Similarly, for a “pre-disability income” step, the pre-disability income period (e.g., the period based on which the PDI is calculated), a link to documents from which the PDI was calculated (e.g., tax returns), and the calculated PDI may be displayed in a claim detail panel. For an “applicable policy documents” step, a link to all applicable policy documents (e.g., between at least the effective date of the policy and the incurred date) may be displayed in a claim detail panel. Other steps (e.g., “ancillary benefit,” “optional benefit,” basic benefit type,” “offset detection,” “total disability benefit amount, “subtract offset amount,” etc.) may display appropriate definitions (or links to definitions), applicable dates, applicable documents, and calculated amounts and/or conditions.

The disclosed methods, systems, and interfaces enable a claim management system that provides immediate access to all relevant documents related to a claim, so that claims can be calculated with higher accuracy, and the underlying documents can be more easily accessed when necessary for e.g., regulatory requirements, audits, customer inquiries, etc.

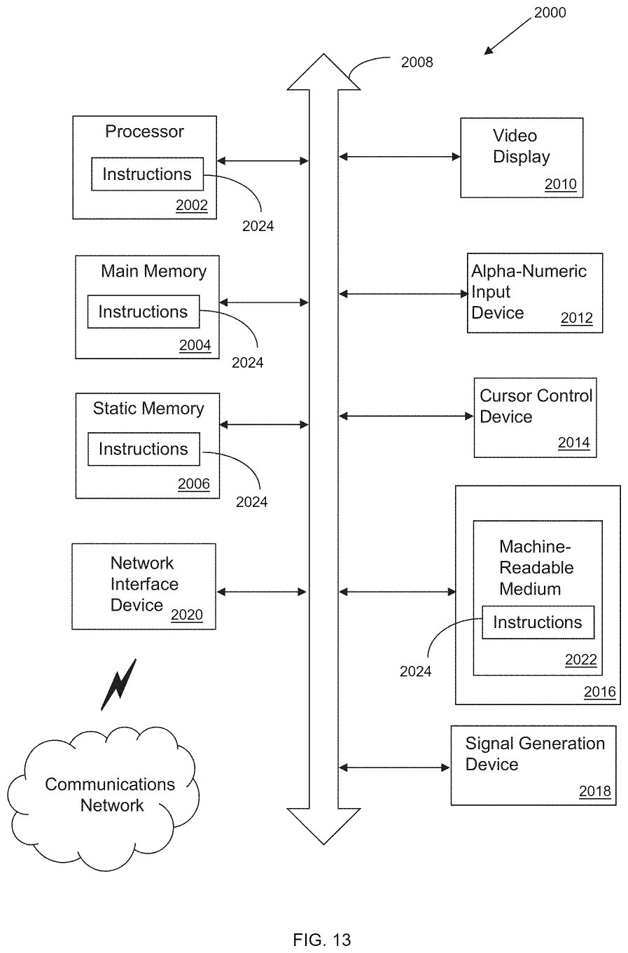

FIG. 13 is a schematic diagram of an example computing system for any of the systems described herein. At least a portion of the methodologies and techniques described with respect to the exemplary embodiments of the systems described herein may incorporate a machine, such as, but not limited to, computer system 2000, or other computing device within which a set of instructions, when executed, may cause the machine to perform any one or more of the methodologies or functions discussed herein. The machine may be configured to facilitate various operations conducted by the systems.

In some examples, the machine may operate as a standalone device. In some examples, the machine may be connected (e.g., using a communications network) to and assist with operations performed by other machines and systems. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 2000 may include a processor 2002 (e.g., a central processing unit (CPU), a graphics processing unit (GPU, or both), a main memory 2004 and a static memory 2006, which communicate with each other via a bus 2008. The computer system may further include a video display unit 2010, which may be, but is not limited to, a liquid crystal display (LCD), a flat panel, a solid state display, or a cathode ray tube (CRT). The computer system may include an input device 2012, such as, but not limited to, a keyboard, a cursor control device 2014, such as, but not limited to, a mouse, a disk drive unit 2016, a signal generation device 2018, such as, but not limited to, a speaker or remote control, and a network interface device 2020.

The disk drive unit 2016 may include a machine-readable medium 2022 on which is stored one or more sets of instructions 2024, such as, but not limited to, software embodying any one or more of the methodologies or functions described herein, including those methods illustrated above. The instructions 2024 may also reside, completely or at least partially, within the main memory 2004, the static memory 2006, or within the processor 2002, or a combination thereof, during execution thereof by the computer system 2000. The main memory 2004 and the processor 2002 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various examples of the present disclosure, the methods described herein are intended for operation as software programs running on a computer processor. Furthermore, software implementations can include, but not limited to, distributed processing or component/object distributed processing, parallel processing, or virtual machine processing, which can also be constructed to implement the methods described herein.

The present disclosure contemplates a machine-readable medium 2022 containing instructions 2024 so that a device connected to a communications network can send or receive voice, video or data, and communicate over the communications network using the instructions. The instructions may further be transmitted or received over the communications network via the network interface device 2020.

While the machine-readable medium 2022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

This specification has been written with reference to various non-limiting and non-exhaustive embodiments or examples. However, it will be recognized by persons having ordinary skill in the art that various substitutions, modifications, or combinations of any of the disclosed embodiments or examples (or portions thereof) may be made within the scope of this specification. Thus, it is contemplated and understood that this specification supports additional embodiments or examples not expressly set forth in this specification. Such embodiments or examples may be obtained, for example, by combining, modifying, or reorganizing any of the disclosed steps, components, elements, features, aspects, characteristics, limitations, and the like, of the various non-limiting and non-exhaustive embodiments or examples described in this specification.

All references including patents, patent applications and publications cited herein are incorporated herein by reference in their entirety and for all purposes to the same extent as if each individual publication or patent or patent application was specifically and individually indicated to be incorporated by reference in its entirety for all purposes.

What is claimed is:

1. A method for processing a claim from a claimant, the method comprising:
receiving claim information;
determining a claim type based on the claim information;
identifying at least one applicable policy based on the claim information and the type of claim;
retrieving at least one policy rule for the at least one applicable policy;
determining at least one claim variable based on the at least one policy rule;
identifying at least one claim document likely to have information relevant to the at least one claim variable;
extracting the relevant information from the at least one claim document;
determining a value for the at least one claim variable based on the extracted information; and
calculating a payment amount based on the determined value.

2. The method of claim 1, wherein the determining the type of claim uses a trained machine learning model.

3. The method of claim 1, wherein the at least one policy rule is extracted from a policy document.

4. The method of claim 3, wherein the extraction of the at least one policy rule from the policy document comprises the following steps:
identifying an applicable section of the policy document based on content of the policy document as compared to the determined claim type;
extracting at least one necessary data point from the identified section;
extracting at least one benefit condition from the identified section; and
extracting at least one benefit based on the identified section.

5. The method of claim 3, further comprising retrieving at least one additional policy rule, the at least one additional policy rule being extracting from a second policy document.

6. The method of claim 1, further comprising displaying a notice to a user when the value for the at least one claim variable is unable to be calculated.

7. The method of claim 1, wherein the at least one claim variable relates to whether the claimant is under medical care.

8. The method of claim 1, wherein the at least one claim variable relates to the date of an incident related to the claim.

9. The method of claim 1, wherein the at least one claim variable relates to whether the claimant is able to work.

10. The method of claim 1, further comprising displaying a notification when a value for the at least one claim variable is unable to be determined.

11. The method of claim 1, wherein the extraction of the relevant information comprises using at least one NLP technique.

12. The method of claim 11, wherein the at least one NLP technique used to extract the relevant information from the at least one claim document comprises keyword identification.

13. The method of claim 11, wherein the at least one NLP technique used to extract the relevant information from the at least one claim document comprises handwriting recognition.

14. The method of claim 1, wherein the at least one claim document comprises an image of a form, the form comprising at least one segment that is machine-printed text and at least one segment that is handwritten.

15. The method of claim 14, further comprising segmenting the image of the form into lines of text.

16. The method of claim 15, wherein the segmenting comprises one of a dilation filter and an erosion filter.

17. The method of claim 16, further comprising classifying each line of text to one of machine-printed text and handwritten text using a trained model.

18. The method of claim 1, wherein extracting the relevant information comprises using proximity information to extract the relevant information.

19. A system comprising one or more processors and one or more storage devices storing instructions that when executed by the one or more processors cause the one or more processors to perform operations comprising:
receiving claim information;
determining a claim type based on the claim information;
identifying at least one applicable policy based on the claim information and the type of claim;
retrieving at least one policy rule for the at least one applicable policy;
determining at least one claim variable based on the at least one policy rule;
identifying at least one claim document likely to have information relevant to the at least one claim variable;
extracting the relevant information from the at least one claim document;
determining a value for the at least one claim variable based on the extracted information; and
calculating a payment amount based on the determined value.

20. A computer program product encoded on one or more non-transitory computer storage media, the computer program product comprising instructions that when executed by one or more processing means cause the one or more processing means to perform operations comprising:
receiving claim information;
determining a claim type based on the claim information;
identifying at least one applicable policy based on the claim information and the type of claim;
retrieving at least one policy rule for the at least one applicable policy;
determining at least one claim variable based on the at least one policy rule;
identifying at least one claim document likely to have information relevant to the at least one claim variable;
extracting the relevant information from the at least one claim document;
determining a value for the at least one claim variable based on the extracted information; and
calculating a payment amount based on the determined value.
